(19) United States
(12) Patent Application Publication
(10) Pub. No.: US 2014/0095417 A1
(43) Pub. Date: Apr. 3, 2014

(54) SDI (SDI FOR EPI-DEMICS)

(71) Applicants: Frederick S.M. Herz, Milton, WV (US); Walter Paul Labys, Fairfax, VA (US); Bhupinder Madan, Basking Ridge, NJ (US); Yael Gertner, Champaign, IL (US); Sampath Kannan, Philadelphia, PA (US)

(72) Inventors: Frederick S.M. Herz, Milton, WV (US); Walter Paul Labys, Fairfax, VA (US); Bhupinder Madan, Basking Ridge, NJ (US); Yael Gertner, Champaign, IL (US); Sampath Kannan, Philadelphia, PA (US)

(21) Appl. No.: 14/043,498

(22) Filed: Oct. 1, 2013

Related U.S. Application Data
(60) Provisional application No. 61/708,292, filed on Oct. 1, 2012.

(51) Int. Cl. G06N 99/00

(52) U.S. Cl. CPC G06N 99/005
USPC 706/12

(57) ABSTRACT

A computer system is adapted to predict the likelihood, temporal (or developmental) state, possible location(s), rate of spread or “infectiousness”, etc. of a potential epidemic. A wide and diverse range of inputs and associated parameters are inputted into the system some of which may be statistically correlatable with certain hidden states including those which are temporally oriented disease stages of progression as well as other types of attributes. A Dynamic Bayesian Belief Network or other adaptive or machine learning method is used for the probabilistic analysis. The system statistically analyzes and reanalyzes the totality of all recently updated information (and within the context of all past information), as can efficiently be modeled by the Dynamic Bayesian Belief Network or other adaptive or machine learning method to provide updated predictions and to suggest a recommended reactive protocol to an epidemic.

### CROSS REFERENCE TO RELATED APPLICATIONS

This application claims benefit to U.S. Provisional Application No. 61/708,292 filed Oct. 1, 2012. The contents of that application are hereby incorporated by reference.

### TECHNICAL FIELD

The invention is directed to a computer system that monitors and processes a wide array of medical, commercial, criminal, and private records and communications to predict epidemics and to take emergency measures.

### BACKGROUND

Even in these modern times the risk of disease and epidemic are high, especially given current incidents of bioterrorism. What is especially dangerous is that it may take several days, or even weeks, before medical authorities are aware that an epidemic is underway; at such a point it may already be too late to track down those who are infected, and further infections and deaths may be very difficult to prevent. Although information consistent with an epidemic may be evident beforehand, it is normally too widely scattered for any patterns to be detected at the local level. A typical epidemic might be presaged by warnings issued by international legal authorities. People may stop coming to work, buying large amounts of over-the-counter medicines for home treatment. They may also start to visit different medical clinics, although in many cases doctors may mistake the true (perhaps exotic) disease for the common cold or flu and any associated common non-diagnostic signs such as skin rashes may be overlooked as occurring in much more benign diseases until much later in the progression in severity of the disease.

There are currently several epidemic-detection systems under development. Examples include the work being done by Dr. Kenneth Mandl at Children's Hospital in Boston, and the work being done by Dr. A I Zelicoff at Sandia National Laboratories (the Rapid Syndrome Validation Project). While useful, such projects are fully focused on only one aspect of automated epidemic detection—the real-time collection of data from doctors through the use of electronic forms. Such systems would certainly be of use in the detection of emerging epidemics, but they suffer from two major flaws. First, because they are mainly concerned with the collection of electronic information from doctors, they are using only a very narrow subset of the data that is potentially available. Second, they do not control for misdiagnoses. For example, they would take the appearance of multiple cases of chickenpox at face value, rather than inferring that a smallpox epidemic was underway.

At an early phase, the distinct pattern of an emerging epidemic will only be evident to a system with a “bird's eye” view of the situation, one that pulls together and analyzes all of these various strands of information simultaneously. U.S. Pat. No. 7,630,986 entitled “Secure Data Interchange” and incorporated herein by reference outlines the SDI architecture, a generalized framework for the collection, analysis, and retransmission of relevant data subject to the desired privacy disclosure and usage criteria of its purveyor(s) as authorized in a “data privacy policy.” In one preferred implementation of this privacy architecture, individual users may be assured of retaining their complete unintruded privacy and/or pseudonymity provided that their behavior patterns are “non-suspicious” cause for concern regarding the overall safety of others.

There are a variety of implementations of the SDI architecture. Especially useful to the present system (described below) is SDI's ability to collect, analyze, and then selectively disclose statistical data, trigger alert notifications (or urgent warnings) and/or recommended response actions to individuals, organizations, or other entities. In particular, if a high degree of user privacy were desired (in many situations it is already legally mandated), SDI would enable authorities to detect and dynamically treat epidemics, while protecting the privacy of individuals through various means (behavioral profile pseudonymization, randomized aggregates, etc.). As will be explained below, the present application discloses a direct application of the SDI information gathering and processing system to the detection and prevention of epidemics in focused population centers (the region of interest might encompass a town, a metropolitan area or some subsection thereof).

An improved epidemic detection system is desired that leverages the capabilities of the afore-mentioned SDI information gathering and processing system.

### SUMMARY

This invention, SDI-EPI (SDI for EPI-demics), makes use of a widely scattered web of informational inputs, as well as advanced data processing capabilities, to solve the problem mentioned above. In a “sentry mode”, SDI-EPI monitors and processes a wide array of medical, commercial, criminal, and private records and communications. One of the strengths of the present SDI-EPI system framework is that the pattern detection methods described below will leverage (in combination) many different variables from many varieties and formats of merged data sets. The system statistically analyzes and reanalyzes this information on a frequent basis, producing updated estimates for the probability that an epidemic is underway.

The present epidemic prediction system (SDI-EPI) greatly expands both the number and range of types of data sources analyzed. Moreover, its use of probabilistic methods to analyze these data sources allows it to disregard particular inputs (for example, inaccurate medical reports) when it is likely that errors have been made or the system could certainly even make use of inaccuracies (such as misdiagnoses) so long as there are consistencies which correlate with the occurrence or relevant observable criteria (e.g., symptoms) which are associated with the actual true epidemic.

The probability of an epidemic is constantly communicated to a proper medical/legal/governmental authority, such as the Center for Disease Control (CDC). When the probability of emerging epidemic passes a certain threshold, SDI-EPI enters an “Alert Mode” and the authorities are sent a direct warning along with data explaining why the alert was triggered. This may well include the identities and coordinates of currently ill individuals who seem to form the current core of the epidemic—they can then be immediately screened, treated, and quarantined, if need be. More importantly, these first clues may cause the CDC to turn around and authorize SDI-EPI to enter a “Reactive Mode.” In this mode, SDI-EPI passes warnings and relevant information along to a wider circle of authorities, tracks the last few days' geographic coordinates of suspected victims (these are correlated with all other geographic records so that anybody who has had contact with the victims can be identified for treatment), and optimizes the usage of hospital resources for the upcoming epidemic. At a more general level, SDI-EPI may suggest and/or autonomously implement a recommended reactive protocol (RRP).

In a preferred implementation, medical and political authorities manually construct reaction rule sets tailored to a wide range of diseases and epidemic conditions. Some of these manually constructed rule-sets may include RRPs which specify which authorities to alert, which disease statistics are to be collected and relayed and to whom, which recommended strategic course of action (RSCA) is to be followed, and which statistical models are to be used for the active analysis of the ongoing epidemic. As part of a specific RSCA, other rules may control or make recommendations regarding the release of certain information to the general public and/or certain specific sectors thereof (e.g., health care professionals, physicians, hospitals, medical suppliers, local pharmacies, pharmaceutical corporations, local departments of transportation and traffic monitoring/control centers, law enforcement authorities, regional press media as well as its national counterparts, local employers, educational institutions, etc.). Of course, many of these prescribed RRPs may be overridden by the associated governmental, legal and/or medical authorities at any point.

One means of reducing the incidence of “false alarms” as well as improving the overall sensitivity to relevant conditions of concern may involve not only the incorporation of relevant epidemiological data, but also the incorporation of such “external” variables as increased terrorist activity, political events, or international tensions. It is conceivable, as well, that certain preferred RRPs will also be influenced by such external variables. In addition, by using SDI-EPI's wide reaching web of inputs, it is possible to use the system to partially keep track of likely terrorists, their organizations and events that are likely to be associated with them. For example, statistical NLP may be used to monitor various types of communications, including spoken communications, various inputs used in U.S. patent application Ser. No. 10/369,057, filed Feb. 17, 2003, entitled “Location Enhanced Information Delivery System,” now abandoned, to extrapolate likely user identities and locations (ranging from license plate scanners, video cameras, location of credit card usage, locations of wireless cell usage, and even anonymous voice communication, e.g., using speech recognition analysis). For this type of complex monitoring continual statistical analyses are useful, as well as implementation of certain expert rules that may be tailored to reveal certain potentially important or alarming activities in which terrorists or likely terrorists may be engaging (e.g., purchase of large quantities of petroleum containing products, voice or email communications relating to bomb making activities and/or with reference to a certain event involving a large gathering of people which could be the basis for a particular set of adaptive rules, for example). Another example could include physical travel of certain suspicious individuals to a single locality. Another could include transmission of diagrams and/or information which has a high statistical probability of being encoded into language which is contextually anomalous to that particular individual or group of individuals.

In addition, a Bayesian Belief Network reveals the combination of anomalous (or predictably concerning) behavior or communication patterns, their occurrences associated with a certain individual (s), commonalities of these patterns occurring among certain suspicious individuals as well as their occurrence among multiple suspicious individuals (which in itself could be the basis for concern). The latter modality may also be a means for detecting, for example, the presence of use of an enciphered code as regular speech, but used to hide “hidden messages”. Rules applied to variables relating to emergent patterns within a population suggestive of an epidemic may also be constructed to improve the model's overall efficiency. For example, if the number and location of a sub-population of individuals exhibiting suspicious symptoms is consistent with the rate of spread of the disease, affected individuals who were in physical contact with other affected individuals (based on their intervening known physical location), it may be possible to retroactively predict a specific location where all of the small group of originally infected individuals were physically at the same time. This may be a further input variable, adding probabilistic weight to possibility of an actual epidemic emerging.

Templates could also be used, e.g., trigger an alert if a suspicious individual contacts other suspicious individuals more than once a month or if s/he travels near a petrochemical plant, toxic waste dump and/or food processing plant more than y times in a given period or y times in a given period where y=AB wherein A=the number of individuals whose suspicion threshold exceeds C and B is the frequency in which A number of individuals travel over such types of facilities.

Other useful characteristics of the system include expert and probabilistic based models of likely human travel and dispersion patterns from a given site of likely infection to supplement the attributes of the model based on more objectively derived deterministic probabilities. There are other types of probabilistic statistical data models whose constituent attributes and state variables may be incorporated into the present SDI for EPI-demics model. For example, such schemes may include probabilistic determinations of chemical weapons attacks, cyber warfare attacks such as detailed within U.S. Pat. No. 8,490,197, entitled “SDI-SCAM,” as well as probabilistic identification systems such as surveillance based facial recognition schemes, object recognition schemes, chemical constituent determination and recognition schemes, and probabilistic schemes for predicting the likelihood of individuals to be associated with terrorist groups or criminal activity based upon personal data collected about an individual as described in U.S. patent application Ser. No. 11/691,263, filed Mar. 26, 2007, entitled “Database for Pre-Screening Potentially Litigious Patients.”

### BRIEF DESCRIPTION OF THE DRAWINGS

The various novel aspects of the invention will be apparent from the following detailed description of the invention taken in conjunction with the accompanying drawings, of which:

FIG. 1 illustrates the inputs monitored by SDI-EPI in accordance with the invention.

FIG. 2 illustrates an example of how a Bayesian Belief Network can be used to construct the probabilistic model at the core of SDI-EPI.

### DETAILED DESCRIPTION OF ILLUSTRATIVE EMBODIMENTS

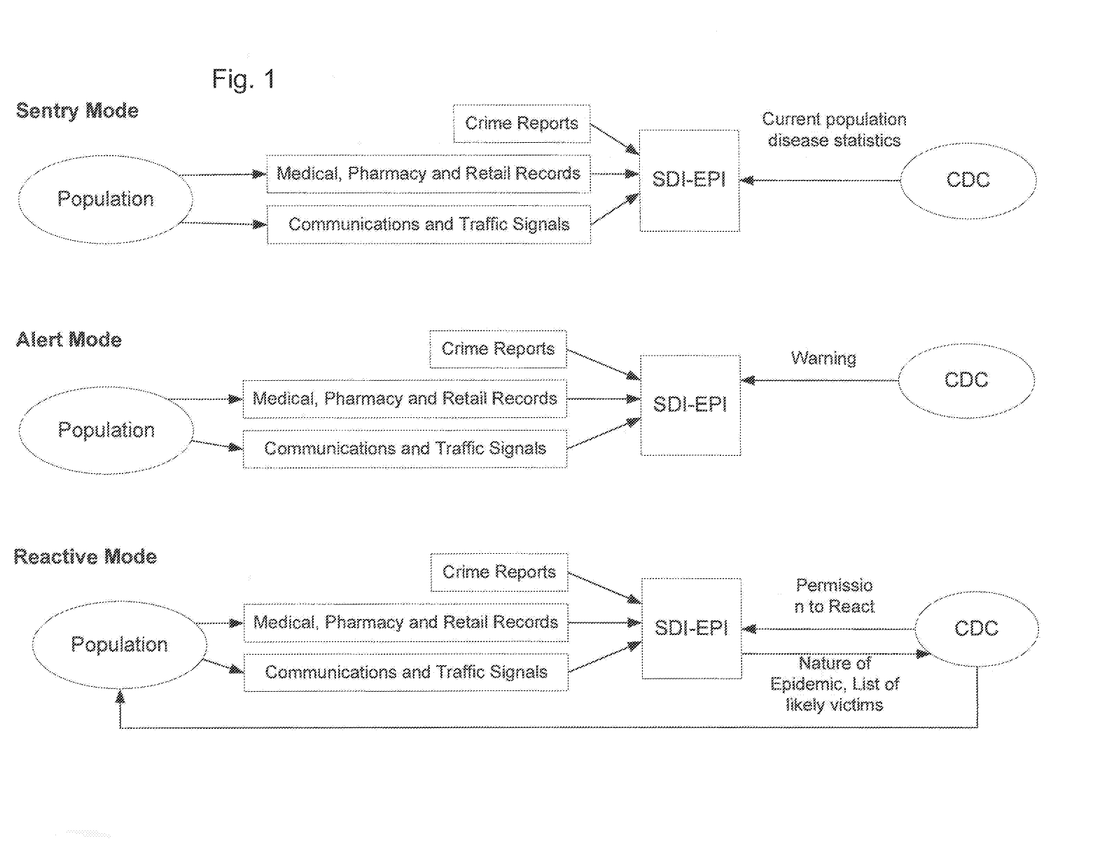

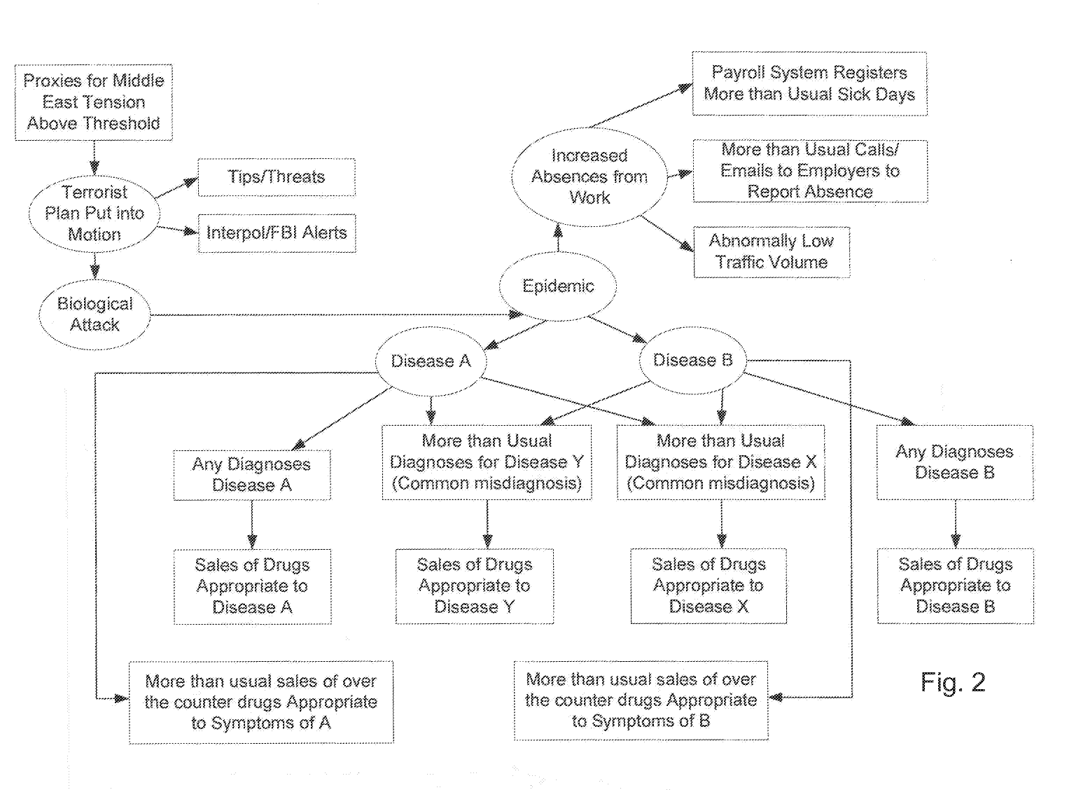

The invention will be described in detail below with reference to FIGS. 1-2. Those skilled in the art will appreciate that the description given herein with respect to those figures is for exemplary purposes only and is not intended in any way to limit the scope of the invention. All questions regarding the scope of the invention may be resolved by referring to the appended claims.

### Overview

The present system and method describes an approach which is based upon both probability and causality for use in predicting the likelihood, temporal (or developmental) state, possible location(s), rate of spread or “infectiousness”, etc. and potentially of any of a variety of “hidden states” of interest in predicting, detecting and characterizing a potential epidemic. A wide and diverse range of inputs and associated parameters are inputted into the system some of which may be statistically correlatable with certain of the hidden states (including those which are temporally oriented disease stages of progression as well as other types of attributes). To this end one of the preferred methodologies for analyzing and quantifying important causal relationships according to their associated probabilistic likelihoods and associated temporal dependencies is the use of a Dynamic Bayesian Belief Network or other adaptive machine learning system or method known to those skilled in the art. While epidemics are very difficult to prevent, the dynamical highly distributed nature of an epidemic prediction data model as well as its ability to predict such useful potentially hidden states as stage of the epidemic, rate of progression, degree of infectiousness, geographic areas of infection, and location of initiation/origin is very valuable in containing the infected individuals and locales and preventing further infections and deaths in preemptive fashion. The other useful functional considerations for use with such a data model is enabling human experts to be able to manually provide expert knowledge or manually determine adaptive probabilities of relevant hidden states (or other attributes) wherever appropriate and/or their correlations to other attributes. It is also important in a system with such a large number and diversity of variables for experts providing such expert knowledge to not over teach the system in this regard, such as defining “normal” user behaviors or other types of variables with too much inflexibility. Still another critical function of such a system is its ability to statistically analyze and reanalyze the totality of all recently updated information (and within the context of all past information), as could efficiently be modeled by such a scheme as the heretofore mentioned Dynamic Bayesian Belief Network or other adaptive machine learning system or method known to those skilled in the art.

### Sentry Mode

In sentry mode (see FIG. 1), SDI-EPI monitors a vast web of inputs (note that the particular inputs described here are not exhaustive—many other types of inputs could be considered in a particular implementation) relevant to the health of a large region (for example, an urban area), watching for signs of an epidemic. In practice, SDI-EPI employs a statistical model to determine the likelihood that an epidemic is occurring, given the external signals it receives. These external inputs may consist of any feeds deemed relevant for a particular system configuration; they may include everything from static database records to signals relaying such “temporal” information as sequential patterns of variables, their total relative durations, their values, rates of change and relative distributions and relative changes to one another.

Primary Inputs

SDI-EPI receives (but is not limited to) the following inputs (through electronic links to relevant databases):

1) General health statistics, both current and historical. These can be used to construct a baseline profile for the health trends normally seen for a given population (including such seasonal, but expected, events as winter flus, etc.).

2) Pharmacy sales, both current and historic.

3) Retail sales records, including such non-prescription medical items as Echinacea, flu drugs, humidifiers, orange juice, electric blankets, etc.

4) Present/recent rates of driver citations/warnings issued by local police.

5) GPS tracking signals emitted by suitably-equipped automobiles (e.g. the On-Star system).

6) Gasoline purchases by credit card. Such records would be indicative of disruptions in individuals' daily driving routines, which would be expected in the case of malady.

7) Payroll and employee punch card systems—these would reflect sick days.

8) Electronic employee performance records—these would reveal changes in employee performance and behavior (e.g., late arrival to work, missed deadlines, indications of sloppy performance, irresponsible or unacceptable behavior, etc.)

9) School attendance record systems.

10) Medical record systems.

11) All forms of communications between patients and health-care workers and practices. These would include appointment schedules (as well as notes pertaining to those schedules, such as the specific medical complaints that prompted the appointments), telephone conversations, voice mail messages, and so forth.

12) Airline/Bus/Train reservation systems, indicating where recent arrivals to the region have come from and where they are going. These would also reveal changes in normal behavior patterns, such as a sudden increase in trip cancellations.

13) FBI/law enforcement alerts/warnings/bulletins.

14) News wires—newly released news stories as well as alerts/warnings/bulletins delivered by the media.

15) Personal wireless devices. Many of these now use GPS to reveal location, thus giving a record of an individual's daily movements. Mobile users as well as their associated wireless devices may also be tracked by means of a method disclosed in U.S. patent application Ser. No. 10/369,057, now abandoned.

16) Credit card records.

17) Video camera signals—such video systems are now commonly installed in such public locations as mass transit stations, ATMs, and convenience stores. These could be used to measure the number of passers-by, changes in the number of individuals wearing heavy clothing (such as hats, jackets, and scarves) relative to what is normal for the time of year. They could also note changes in walking speeds, space between individuals, body positions, facial expressions, etc. Behavior interpretation algorithms would yield information on a) the identity of individuals seen, b) their behaviors, and c) their approximate location within the field of view of the camera. This would allow, for example, the identification of individuals in supermarkets lingering over cold and flu-related products.

18) Traffic monitors/fixed highway video cameras/tollbooth collection systems such as EZ-Pass/real-time public transportation system monitors.

19) Records related to entertainment and social activities—these would reveal decreases in such activities as visits to the g˜ and cancellations of pre-purchased or pre-reserved events such as concerts, hotel stays, and restaurant dinners. These would also reveal increases in missed social engagements or other appointments, as reflected by phone and email communications and/or electronic calendaring systems.

20) Electronic calendaring systems—these would reflect increases in the cancellation or rescheduling of meetings, appointments and socially or recreationally oriented engagements.

21) Ambulance company records.

22) Taxi and limo companies' records—these can be used to determine changes in the use of taxi service relative to other modes of transportation, such as walking or public transport. It is likely that an ill individual would be more likely to use a taxi than walk, for example.

23) Mortuaries.

24) Web site visits—e.g., monitor browsers' locations and information requested. Individuals who are beginning to feel ill, but do not yet exhibit serious symptoms, are more likely to visit on-line health information systems (such as WebMD) before consulting with health care providers. By monitoring individuals' browsing behavior it would be possible to spot possible infections very early into an epidemic. Web monitoring would also reveal whether an individual was working seriously or engaging in recreational browsing.

25) Smart home system logs—U.S. Pat. No. 7,630,986 discusses a home/office information system capable of monitoring and reacting to the needs of users within its environment. This system uses statistical methods to analyze users' present and predicted behaviors, needs, and interests; it then provides users with services and information as appropriate. Such a system could readily detect even subtle variations in a user's daily routines.

26) Digital television viewing logs—these would reveal changes in viewers' normal viewing patterns. For example, is a viewer spending more time watching television, watching television at odd hours, or spending an increased amount of time viewing programming related to health issues or current events?

27) Disease database—This complex database would include descriptions and symptoms of all known diseases, including common misdiagnoses and their likelihoods (i.e., a small-town doctor is likely to misdiagnose smallpox; however, he is more likely to misdiagnose it as chicken pox than as heart disease). Such a database would be constructed with the help of bioterrorism experts, tropical disease experts, pathologists, etc. The database could even incorporate misdiagnosis probabilities based upon the professional profile of the particular physician, e.g., quality of education, field of specialty, experience/exposure in treating different diseases, experience treating patients in the Third World and/or regions where exotic diseases are known to be more prevalent.

28) Telephone voice logs—These could be used to reveal changes from a user's normal voice and intonation. For example, a hoarse, nasal, and/or lower tone would reflect the pharyngeal-mucosal swelling characteristic of maxillary sinus congestion. Coughs and sneezing could also be detected, as would distressed or anxious vocal tones, changes in normal speaking speed, and so forth. The content of conversations could also be scanned for health-related issues, sober topics of discussion, etc.

29) Home computer usage logs—these could reveal changes in users' application and content usage, and could monitor for deviations from normal typing/moussing speed and cadence.

30) ATM usage.

31) Stock market trading patterns—Are there any “suspicious” stock trading activities suggestive of a “knowledgeable” insider with prior awareness of the occurrence of a catastrophic event? For example, immediately prior to the terrorist attacks of September 11, certain dealers sold short a particularly large number of stocks. An early warning system for terrorism could scan for such signals.

Immediate Feedback

In certain cases, it would be possible for SDI-EPI to provide immediate feedback at the point of input. For example, one could imagine an implementation in which emergency room doctors are alerted of possible alternative diagnoses even as they enter data for new patients (e.g., a doctor entering the observations of “high fever” and “skin rash” would work through an automatic decision tree, linked to the core disease database, that would warn him of such alternative possibilities as smallpox). Such immediate feedback systems would be especially useful because they would be updated as frequently as their underlying databases, allowing, for example, doctors nationwide to be made immediately aware of exotic new disease threats.

Implementation of the Predictive Model

SDI provides the framework needed for collecting the data by monitoring a region's communications, medical records, sales patterns, traffic flows, and so forth. SDI pulls together the strands of information that, collectively, may provide early signals of a developing epidemic. In the preferred embodiment, the many sources of data collected by SDI are brought together onto a central server, which at some frequent interval (e.g. hourly, half-daily) runs a predictive model to calculate the probability that an epidemic is currently in progress. This predictive model may obviously be constructed in many different ways.

In a preferred embodiment, a Bayesian Belief Network is used. The simplest types of Bayesian Belief Networks are directed acyclic graphs that encode conditional probabilistic relationships between various event nodes. Realistically, it is likely that the complex graphs used for this application will include cyclical elements (in other words, more than one semi-path may exist between any two nodes); this makes the calculation of conditional probabilities more complex, but still within the realm of solvability (using known state-of-the-art statistical methods).

The network can be constructed by human domain experts who understand the many factors involved in epidemics, as well as their causal linkages. These factors include those things that would impact the probability of an epidemic occurring (for example, the theft of anthrax from a government installation), as well as those things whose probabilities of being observed are impacted in turn by the occurrence of an epidemic (for example, an increase in aspirin purchases). Because the central event of interest—the occurrence of an epidemic—may not be directly observable in its early stages, the calculation of its probability will be heavily conditioned on those factors which are directly observable.

Once the network connections are established, the conditional probabilities for the event nodes must be defined. Although it is likely that most of these will again be constructed by human experts, there are well-known machine learning methods that would allow the probabilities to be calculated directly from a training data set. Certainly, once the system has been in operation for some time and enough data has been collected, the overall accuracy of the network could be improved by training it on the new data.

FIG. 2 shows an example of how a Bayesian Belief Network can be implemented on a computer and used to construct the probabilistic model at the core of SDI-EPI. Note that this is only one embodiment, and that different structures and/or different variables may be built into it. For this example, observable events as boxes and unobservable events as ovals are indicated. Note that the direction of the arrows indicates which events have an impact on the probabilities of the events that follow. The oval representing the epidemic itself is in the middle of this network: some events feed into it, and it feeds into other events. The information contained in both the “parents” and the “children” of the epidemic event will be used in the calculation of its conditional probability.

The first part of the model represents the effect that international terrorism can have on the likelihood of an epidemic (i.e., a biological attack can be the direct cause of an epidemic). One can observe proxies for tension in the Middle East (price of oil, number of weekly casualties in the Israeli/Palestinian conflict, etc.); the greater these values, the more likely that a terrorist attack will be put into motion. If this happens, there will be a heightened probability that insiders will alert the world media with tips or threats, and that international crime-fighting agencies may sense activity and issue blanket warnings. Most important, if a terrorist attack is put into motion, there's a possibility that it will take the form of a biological attack. This directly increases the probability of an epidemic taking place.

One of the first consequences of an epidemic will be that more people than usual will likely not feel healthy, and will stay home from work. Although one cannot directly observe increased absences from work, one can directly observe the effects of it: payroll systems will register more sick days, individuals will make more calls to schedule appointments with their personal/family physicians and (very similarly) employees will send SDI-observable telephone calls and emails telling their employers that they will not be coming to work (standard voice-recognition and natural language processing tools can be used to extract this information), and automobile traffic will be lower, a fact which could be directly observed by monitoring passage rates at toll booths or traffic monitors at intersections, for example.

If an epidemic occurs, there will be a range of probabilities governing the particular diseases that might occur. In this case, one may consider fairly deadly communicable diseases A and B. Note that these are quite out of the ordinary (e.g. smallpox) and would normally not be observed in the region, even during a typical cold and flu season.

Note that there are then three sets of observable information that can be affected by the occurrence of diseases A or B: medical records (to keep things simple, the inventors consider only electronic records containing diagnoses of patients by doctors), pharmacy sales records, and retail records.

If diseases A or B occur, there's a possibility that especially sharp doctors will recognize them and diagnose them appropriately (such an event would probably short circuit the inference—which is herein performed by SDI-EPI—if disease A or B is sufficiently virulent the doctors would probably alert the appropriate authorities directly).

More likely, however, doctors will misdiagnose disease A or B as the much more common disease X or Y (e.g., a doctor would probably be much more likely to diagnose the initial rash caused by smallpox as the much less dangerous chicken pox). As mentioned before, a human expert could calculate the likelihood of, say, disease A as being misdiagnosed as disease X, and build this into the probability distribution. This could then be updated as more data is collected over time. As experience and knowledge regarding the occurrence and potential threat of specific epidemics is acquired by health care professionals, it is likely that the occurrence of misdiagnoses will decrease and it is thus appropriate to accordingly adjust the model so as to be able to correct for these probabilistic changes based upon changing knowledge and awareness on the part of health care professionals.

Under the preferred embodiment, such medical records would be fed directly into SDI. However, even if every diagnosis is not captured electronically, pharmacy purchase records will reveal patients' behaviors after they have visited their doctors, and will thus give clues about the nature of their diagnoses. Note that certain drugs may be stronger indicators of particular diagnoses than others (for example, the increased sale of aspirin in pharmacies would probably be consistent with a wide variety of diseases, whereas a very specific drug intended for use only on chicken pox would be highly indicative of a chicken pox diagnosis having been made).

The final set of information is gathered at the retail level, and is probably the least specific of the three sets. Sales at retail outlets will reflect the behavior of patients directly treating their ailments. For example, if disease A causes dryness of mouth and headaches, an epidemic of disease A might be signaled by increased sales of humidifiers and aspirin at retail outlets throughout the region. Combinations of treatments purchased at the same time and by the same individuals would likely signal the multiple symptoms exhibited simultaneously by particular diseases. If the disease were small pox and the symptoms included flu like symptoms and skin irritations, one would want to look for purchasing patterns which treat the combination of these symptoms or more specifically certain types of medications which are in certain ways differentially unique in their relative proportions from those purchased during a common flu outbreak, e.g., a higher proportion of drugs for “flu-like symptoms” such as fever, aches and pains (such as aspirin) respiratory infection such as cough medicine versus drugs typically used for “cold-like symptoms” exclusively such as anti-histamines or which are common therapies for a combination of symptoms which if emergent simultaneously are unusual for a flu or cold outbreak, e.g., treatments/remedies for fever, aches, respiratory infections AND skin irritations. These patterns could, for example, be detected via individual credit card purchases, retail and pharmacy purchase records including whether and to what degree increases in purchases of these combinations of medications are occurring on the same sales transactions.

In actual operation, SDI would sample the data sources represented in FIG. 1 by the boxes. For example, it might scan the news wires for news of trouble in the Middle East, monitor traffic conditions during rush hour, monitor retail outlets' inventories (in other embodiments it might also watch for erratic driving or walking patterns), etc. Through the use of standard Bayesian Belief techniques the probabilities of the unobserved events in the ovals (per FIG. 2) would be calculated, in particular the probability that an epidemic is actually ongoing. Suppose that a high-profile terrorist has just escaped from prison and that Interpol issues an international alert that the terrorist has a background in biomedicine. Furthermore, the morning rush-hour is especially light, pharmacies across the region are selling chicken pox medication, and Wal-Mart has sold out of hot-water bottles and rash cream. Taken singly, any one of these events would be slightly unusual, but certainly no cause for concern. Gathered together and run through this Bayesian Belief Network, however, these data points might result in the calculation of a very high probability for a smallpox epidemic. If the probability passes a pre-set threshold, the authorities could be alerted very early into the epidemic.

The model is flexible in that more events and conditions can be linked into the network as desired, incorporating more complex types of variables. For example, a measure of the rate at which an epidemic spreads might be desirable for purposes of disease identification. This rate would be reflected in the rate of change of the other observable variables (e.g., a very virulent outbreak would be presaged by much faster rates of work absence, than might be seen, for example, during a normal flu outbreak). An additional observable aspect of the epidemic phenomenon, which the Bayesian Belief Network is suitably equipped to handle, is the rate of change of the various features. For example, rates of drug or remedy-related purchases will be affected significantly by increasing numbers of victims. Other variables will also change significantly. Factors which are directly indicative of the number or change of number of infected individuals on a collective scale within a given period of time are also correlated with the rate of spread of the disease within a given area (which is one variable affecting degree of infectiousness). For example, some of these variables may include the total number of sick days in a given area, total reduction of automobile traffic, total medical records with suspicious symptoms. Biological agents, which are spread communicatively, have not only a much higher degree of virulence, but also a much higher degree of infectiousness. The Bayesian Belief Network can take all of the relevant variables and its rates of change into account, which relate to total numbers affected and thus differentiate its contagiousness from that of standard cold or flu strains. In addition, the temporally-based epidemiological differences from that of other more common and benign diseases may also be captured by the Bayesian Belief Network, i.e., the duration or life cycle of the infection, associated severity, incubation period, period of contagiousness. It is reasonable for certain other potential sequential-based patterns to be further identified by applying certain hand-crafted rules as part of the Bayesian Belief Network. This approach may be particularly useful in capturing certain details, which are specifically relevant for purposes of determining which strategy and logistics of planning the response strategy which is most appropriate based upon the presently observed set of conditions. In addition, if these variables (as reliable data associated therewith) are not readily accessible through the present input modalities used with SDI-EPI, it may be of potential value to automatically construct a decision tree which is able to selected which variables are the most useful in determination of a variety of conclusions, e.g.:

1. The presence of an emerging epidemic.

2. The determination of which epidemic may be initiating.

3. (If relevant) which relative strategy to pursue based upon the present state and conditions overall.

There are certainly many things that need to be taken into consideration during the construction and design of the system presented here. Architects of such a network may be helped by a decision tree system disclosed in issued U.S. Pat. No. 5,754,938. In that patent, a system is disclosed in which a decision tree is used to select those key variables of the greatest relevance to a predictive task. Those individuals predicted to have the most knowledge and experience with regard to those particular key variables could then be consulted for relevant assistance.

Advantages of SDI's Ability to Leverage Both Statistical Patterns at an Individual and at an Aggregative Level

For purposes of detection of suspicious patterns which are potentially revealing of an epidemic in progress one fundamental characteristic of the basic SDI architecture which makes it so ideal for epidemic detection is its ability to utilize statistics as input to the model across user populations wherein these statistical patterns are monitored and collected at the level of the individual in as much as, for example, subtle changes at an aggregate level are likely to be less pronounced than when such aggregative trends of these populations detect differential changes in behavioral and other attributes at the level of the specific individuals as opposed to averages of all individuals within that population. In addition, there may be occasional (perhaps even typical) variations of certain significant variables which when observed in a purely aggregated form, will not reveal any statistically significant changes, however, this may not be the case. For example, 1) the occurrence of a variable for certain individuals is abnormally high (or low) particularly for their own level of normality, and 2) certain variables, changes which are very small could, based on aggregate data, be explained by other intervening variables of a benign nature. However, if those other variables are clearly not present to provide such an explanation, there may be a potential cause for concern (this is a further benefit of SDI-EPI's utilization of a wide range of types of variables). In reality, however, availability of such individual-level statistics (depending upon the type of data) may be of limited availability or completely unavailable or it may, in perhaps the preponderance of cases, be available for only a fraction of the user population. Because by nature of the herein addressed problem, it is also of importance to detect any patterns at all which are potentially revealing of an emerging epidemic at the earliest possible time and because many of the changes in a given population are likely to be quite subtle (especially initially), it is also of critical importance to leverage as large a volume of available data statistics as possible from its allocated input sources, including those which are available at a purely aggregate level, in particular (in as much as typically such aggregate level data will constitute a much larger proportion of the available statistics compared to that of the individual level).

U.S. Pat. No. 7,630,986 also provides detailed specifications for very useful techniques (such as enhancing the statistical confidence of sparse data sets, bootstrapping, etc.) by which it is possible to “enrich” statistical data by merging or “chaining” of multiple data sets (including those with homogeneous and/or heterogeneous features). One of the strengths of the present SDI-EPI system framework is that the pattern detection methods described below will leverage (in combination) potentially all variables from all varieties and formats of merged data sets. This includes aggregated sets consisting of individual user specific data sets and purely aggregate-level data which is enriched by individual specific and other aggregate-level data sets.

### Alert Mode

Temporally Dependent Attributes, Hidden Attributes and Hidden States

The SDI-EPI system is designed to detect the possibility of an epidemic. The system does this by statistical analysis of the input data that it receives (FIG. 1). Using the statistical analysis on the input data from all the sources listed above the system decides what is considered the “normal” behaviors in the system by statistically deciding what patterns happen with great frequency and likelihood. The system can then detect any deviations from the “normal” state. In a case where the system operates under a high false positive rate, then the system can alert experts whenever there is any deviation from “normal.” The experts can then analyze the data and tell whether this is a false positive. They can then give feedback to the system that this deviation is within acceptable bounds. In addition to this, the experts based on their knowledge can also determine in advance what the false positives might be and input this data into the system. The feedback and the input to the system are done by setting the parameters in the Bayesian Belief Network. Yet, the experts will be careful not to over-teach the system what the acceptable states might be because it is not possible to completely predict in advance which states are epidemic states. For example, in the case of a terrorist attack, or a terrorist spread of an epidemic, it is likely that the deviation from normal will not consist of a statistical pattern that is easily predictable. Moreover, it is especially difficult for humans to describe rules when a large number of combinations of different variables are considered. Therefore, the SDI system benefits both from human expert knowledge in some cases and from the sensitive types of Belief networks which detect complex anomalies which are difficult for humans to detect.

Depending on how dangerous the disease is and on the rate in which it spreads the system can be designed to have more false positives. This also depends on how the system is designed to react to an alert. If the alert is only of an informative nature, for the purposes of expert study, then it is beneficial to have a high false positive rate. If the alert causes an emergency reaction of distributing shots to all the people in the area and shutting down access roads then it might be more beneficial to have a low false positive rate.

When the SDI-EPI system detects that there is a possibility of an epidemic, it must make the following two decisions 1) where are the possible places where the epidemic might spread in the future, and 2) where are the other places where the epidemic has already spread and was not yet detected.

The process which decided where the epidemic could spread over time can be modeled by a Hidden Markov chain (or other similar type method). For example, the nodes in the Markov chain denote all possibilities of the different locations which the system monitors. The edges between two nodes A and B denote the probability that the disease might pass from all the locations in node A to all the locations in node B in a given time unit. Using this model the system can determine with which probability the epidemic will spread to each location after some t units of time.

The probabilities on the edges in the Hidden Markov chain will be determined by the experts both by some pre-process computed in advance and by an online updated process. In the pre-process, the probability will be determined by reasoning from the “normal” description of the system. For example, geographic proximity of locations, and frequent travel from one location to another may be determined The online process will compute the probability based on the data available from the deviations from the “normal” state. For example, if some unusual travel was performed between two locations this could also cause the spread of the epidemic.

The time unit t could be determined by experts based on the particular disease that is dealt with. When there is a prediction that the epidemic might spread to a certain region there is also a time frame that is associated with the spread. For example, some diseases cannot be detected immediately and can only be diagnosed after a certain time passes. In addition, there is a time frame by which it is clear that the disease was not contracted by the patients in the area.

Once all the locations and their associated probabilities are determined and after the appropriate time frame is determined, the locations with high probability are alerted with a warning. The locations with small probability can also be alerted with a watch which is a milder form of an alert. The places with high probability might be given a preemptive treatment whereas the locations with small probability might be watched. As determined by the appropriate time unit some locations can be removed from the watch.

One example of a place with high probability will be a big city such as New York to which many people travel and which has a large dense population. Therefore, when checking the spread of the epidemic it is important to check travel to and from NY to all locations. A place with small probability will be a place that is secluded and sparsely populated. The probability of this place might increase slightly, if there are some irregular trips made from that location to New York. Therefore, while it is important to warn the citizens in a place like New York, it might be sufficient to watch over low probability places which are secluded.

The Markov model is beneficial because it is relatively efficient and outputs the locations and their associated probabilities quickly. One of the reasons it is so efficient is because it is a memory less system. The Markov chain does not determine how the epidemic was spread to a particular location. Rather, it only specifies the probability that the epidemic might spread to that location. This information is sufficient for the purposes of alerting, warning, and watching the locations in danger. In fact, for the purpose of alerting the location the fastest system is most desirable.

In addition the Hidden Markov chain model is beneficial because it allows to model hidden approximate states. For example, it will allow the possibility to output an alert that there is an epidemic detected before being able to determine where exactly the epidemic is. In another scenario it might detect the epidemic but not necessarily the exact disease.

Once the locations have been alerted, it is essential to evaluate the performance of the system have for the purposes of improving its use in the future. The experts will compare the locations predicted to be infected by the system and the actual locations to which the epidemic spread. Human experts will use this comparison to input new probabilities and parameters back into the system. There are of course, many hidden states and variables in which real (validated) statistics and expert estimated or inferred statistics may be inputted as adaptive learning features. The same may equally apply to correlations (as adaptive learning rules). As mentioned before, the Markov chain model is memoryless. Therefore, it cannot determine causality or how the epidemic was spread. For that reason, a Dynamic Bayesian Belief Network can be used. It is similar to a Markov chain, but it does allow to detect causality. In particular, it is more sensitive to time and/or dependent parameters. The experts will use this network to establish better probabilities for future use in cases where there are many different and diverse types of attributes of which a considerable number may be temporally and/or sequentially dependent.

This system performs similarly to the way the weather watch is done. When a dangerous storm is observed in a particular location, the whether watch system calculates the probability that the storm will move to a particular location. The probability is calculated based on the geographical location and also on particular characteristics of this particular storm such as the direction of the wind. All the locations with high probability risk are given a warning, those with lower probability are under watch. After some time passes, the status of the locations changes. However, statistical knowledge learned by the system from all past states is able to be statefully retained and leveraged thus enabling conditions for a continued aggregative learning process.

### Reactive Mode

When the appropriate medical authority (for the sake of example, the CDC) receives an alert from SDI-EPI it must make a decision—is an epidemic really occurring? Human experts can examine the data that triggered the statistical warning system, and teams of medical specialists may be dispatched to test randomly sampled candidate victims. At this point the CDC makes a decision on whether or not to declare an epidemic emergency.

If the CDC declares an epidemic emergency, SDI-EPI (although still capable of monitoring for further disease epidemics and further developments in the current one) is put into a reactive mode. That is, the information that had been accumulated by SDI-EPI to predict the epidemic (FIG. 1) is now used to minimize the impact of the epidemic that is now taking place.

In particular, SDI-EPI employs the following functionalities:

1) It identifies those individuals who have a high likelihood of being infected (the primary victims). This set of people might include those who have purchased certain home remedies, those who have described symptoms to friends over phone or email, those who have been diagnosed for the disease, and those who have been likely misdiagnosed.

2) It investigates potential causes for the epidemic. It does this by focusing on the initial group of infected individuals; then, every piece of accumulated information relating to those victims is correlated. Do their credit cards show purchases at the same restaurant? From their wireless GPS tracks, did they pass through one or a very few geographical locations? Do their phone conversations or emails share any commonalties? Did they recently travel to the same locations? Was there a point (place/times) of intersection with individual(s), suspected to be tied to a terrorist group? All possible pieces of information are analyzed to find common threads between the victims. Note that there already exist several standard data mining algorithms that could be useful for accomplishing this task.

3) It predicts the identities of other potential primary victims who were not identified in step (1). If SDI-EPI is able to determine the location and time of some specific infective event (e.g. the release of anthrax in a particular subway stop), by backtracking through all available locational and temporal information (e.g. people's locations as given by their wireless devices, people's use of credit cards in particular vending locations, face recognition techniques, etc.), it can expand the list of those people who may have had contact with this initial event. This is especially important for finding those primary victims who have not yet developed symptoms (and therefore continue to go to work and otherwise act normally). SDI-EPI can transmit the coordinates of these individuals to medical authorities, and can email or send automated voice messages to the victims, warning them of the situation and pointing them to first aid and health information. Such a warning notification procedure could be achieved by using, for example, standard telemarketing automation technology in addition to other wireless and wire line communication and notification schemes (such as a similar scheme could, of course, readily be extended to such other types of attacks as chemical or nuclear).

4) It identifies the set of secondary victims; that is, those individuals who may have been exposed to the disease through contact with one of the primary victims (identified in step (1)). This is done by first using locational/temporal information to recreate the paths taken by primary victims over the last several days. These paths (and locations visited) are then correlated with the paths of all other individuals known by the system, and a list of those individuals most likely to have been in close contact with a primary victim is generated. This list might include, for example, people who ate lunch in a fast food restaurant next to a primary victim, coworkers of primary victims, family members of primary victims, etc. All of these contacted individuals may also be at risk, depending on the nature of the disease. SDI-EPI identifies this secondary set of victims, alerting both these individuals and appropriate medical authorities about their status. This may be repeated for tertiary contacts (those who had contact with secondary contacts), and so forth.

5) It identifies those locations within the geographic area served by SDI-EPI with the highest likelihood of containing infected individuals. It does this by tracking the movements of identified primary and secondary victims, as well as extracting location relevant information from database records correlated with the epidemic (e.g., the home addresses of individuals checking into emergency rooms because of extremely high fevers).

6) It optimizes the allocation of medical facilities. Using records on hospitals, personnel, supplies, and medical assets, as well as information on the current location of the epidemic's victims, SDI-EPI can use standard optimization techniques to ensure that victims are sent to the nearest hospitals in a manner that is orderly and efficient, maximizing the probability that all victims will receive needed care.

7) Given information on the nature of the epidemic, SDI-EPI can transmit automated bulletins to medical and criminal authorities, making requests for more vaccine or sending out further warnings. If need be, regional transportation facilities can be kept apprised of the situation in case a regional quarantine is required.

8) Geographically specific public alert technology has recently been developed to allow for the automated contacting of at-risk individuals via their telephones (and this could easily be extended to include e-mail, pagers, instant messaging, etc.). This technology (sometimes referred to as “reverse 911”) would be useful for alerting specific populations of specific threats, and could transmit instructions tailored to the particular situation. For example, if a reservoir is suspected of having been contaminated by anthrax, all the users of that particular water system could be immediately warned of the danger, and could be informed of alternative sources of water. For example, if a small pox outbreak originally emerged in a particular locality (per the model's reconstruction of probable events), there would likely be an increased likelihood that individuals in that area may be affected, take appropriate measures, e.g., should seek medical screening or treatment for symptoms, stay indoors away from exposure to others (who could transmit or receive the contagious pathogen).

Extended Applications of the SDI-EPI Architecture

Although the use of SDI-EPI for its primary application domain is very befitting, important and timely at the time this present disclosure was written, it would be sufficiently obvious to one skilled in the art that the present SDI-EPI architecture could be adapted and tailored to a variety of other useful application domains. For example, the system's ability to monitor, model and extrapolate certain types of patterns could also be useful in predicting certain types of terrorist activities such as chemical warfare, biological or chemical contamination of water supplies, food supplies including attempts to plan and execute more overt terrorist attacks such as the 9/11 attack on the World Trade Center, pyrotechnic attacks. The system could also monitor technically more advanced forms of terrorism such as cyber warfare attacks such as attempts to hack into secure databases associated with such entities as the Federal Government, the financial community or energy utilities. SDI-EPI could also gather information about activities which extract secure information and/or implant rogue viruses which could interrupt entire networks e.g., major metropolitan power grids or the networks and computer systems used by the financial markets.

In the latter example, certain pre-defined on-line behavior patterns consistent with such rogue behavior may also be monitored. Use of the presently suggested techniques may also be adapted and tailored to the application of detecting potential drug trade related activities and identifying its associated perpetrators (wherein travel patterns and local and international communications as well as person to person communications and meetings (via physical proximity) may also be potentially useful input statistics and the inputs for certain associated rules for such an application).

The present system could even be tailored to develop a probability model which would assess that certain individuals possessing known historical criminal tendencies are likely to engage in further criminal-related activities. The model may anticipate the possible nature of the likely criminal activity of concern by observing many of the parameters akin to such activities. It may even attempt to predict possible criminal tendencies in certain individuals as well as detect behavioral/communication patterns likely to presage certain imminent criminal activities. Since certain criminal tendencies are often associated with certain behavioral, psychological or socio-demographic conditions as well as with certain other types of criminal behavioral tendencies, it helps to model the probability of such activities. Of additional potential value (also a relevant input to identifying other types of “suspicious” types of persons such as terrorists, drug dealers, etc.) is the types of individuals with whom one associates and analyses of any language communications from others who had “known” the individual which are of a descriptive nature of him/her.

The system is designed to single out the core nucleus of individuals, who may be planning on certain terrorist activities. This is done in determining and following the probabilistic profile of committing a terrorist act. Such probabilistic functions could be determined by a system learning method after collecting data from a set of input parameters which occur after a terrorist act. These inputs could be such as: the phone activity among the average population after the incident has occurred. However, a noise in the normal phone activity can point to an unusual act. The noise could be in the form that a certain small group shows exuberance in the phone conversation as opposed to the more common mourning in the most of the phone activity immediately after the event. A plot of number of phone calls versus a measure of population from a certain distance of the ground zero should show an average increase in the phone calls and thus would not give any indication of the terrorist act. However, a plot of a measure of the tone of phone conversations versus a measure of the population would show an inflection in the otherwise increased but average activity in the phone calls. Similarly a buying pattern of certain medicines such as rash medicine will show a spike, which would plateau with time and distance.

Thus, a quick analysis of such a plot would point to an epicenter of an unusual activity. Similarly an analysis of the data going backward time before the event, would provide clues to a future incident. Another Input to the system of use would be, for example, purchases of suspicious materials chemical agents such as hydrothorazine, petrochemicals etc. Observations of such occurrences may have significant ability to tie them in with the probability of a chemical or biological agent attack. SDI-EPI could tie up the suspicious person's phone activity, their purchases, their travel and their communication with other criminals such as drug dealers in order to keep a tab on any unusual activity. SDI-EPI could also collect personal information on the suspected persons by various methods including video monitoring. Neural network techniques could assist in collecting all the information from video monitoring and could in effect determine the exact mood of the person under surveillance and could signal an alert in the event of an unusual activity. Neural network based techniques, which are capable of converting of 2-D object to 3-D objects, would make such an evaluation more robust. Another set of data once made available to the SDI-EPI system could help in locating a chemical or biological agent attack much before it affects a larger population. The behavior of pets and other animals could be gathered and compared to the normal behavior patterns. Normally, it is believed that sometimes pets and other animals have keener sensory perception and hence they will demonstrate different behavior after an extraordinary event much before it is detected by other means. Thus, a difference in behavior pattern of animals and pets would signal an alert by the SDI-EPI system.

Detecting and Anticipating Potential Threats to Homeland Security

As indicated above, many of the same presently disclosed techniques that are used in early detection of epidemic outbreaks may also be extended to the monitoring and detection of potentially suspicious activities as well as behavioral patterns which are anomalous from those of the normal population or are anomalous from previous behavioral patterns of particular individuals or a group of individuals especially across a range of various parameters especially those which are pre-determined as being suspicious. As indicated above and as is consistent with the techniques used to detect behavioral patterns consistent with an early stage epidemic (see “Implementation of the Predictive Model” above) wherein a human expert constructs the model by manually constructing “causal linkages” between relevant factors within a plethora of possible factors such as human behavioral patterns, events, purchases, human-human connections (on line or off line), informational content communicated, etc. As indicated, the preferred implementation of the system uses a Bayesian Belief Network in as much as its key strengths include its ability to monitor a variety and diversity of features from various input modalities and its sensitivity to combinatorial emergence of features with which these pre-determined causal linkages had been established by the expert (or feedback from actual statistical data). Of further significant benefit is its ability to identify these patterns on a relativistic basis, i.e., as they may vary from a present state of normality and as well as in particular from a present state of normality with respect to the behavior patterns of individual users as well as how these individual level divergences may coincide as a function of still other criteria (e.g., temporally or potentially others as well) The application of the invention to epidemic prediction suggests a number of suggested inputs (however, which are in no way limiting) which are used to extract key relevant features which the system can monitor persistently for purposes of real time detection. Although behavior patterns that are consistent with suspicious activities of concern to homeland security are particularly specialized and likely largely likely to be substantially complex in nature, for the sake of concreteness several of these inputs are herein suggested for the application of anticipating such activities as rough individuals planning, conspiring, communicating and/or acting on terrorist related activities are herein suggested below. These example inputs are likely admittedly somewhat crude and perhaps even inaccurate with respect to those which an expert may choose to utilize. However, they do provide a substantive collection of inputs, which are likely to have at least some degree of success when actually implemented. Please note to include PC attacks and vaccine immune viruses for tracking individuals.

### Conclusion

Part of the difficulty of detecting a regional epidemic in its early stages is that although the needed information exists, it is widely scattered and may not be noticeable at the local level This disclosure shows that the SDI information architecture can be extended to collect and analyze data relevant to detecting epidemics. Through the use of a statistical model, SDI-EPI can gauge in real-time the probability that an epidemic is underway; when this probability surpasses a set threshold, a warning can be passed along to the appropriate medical authorities. If it is determined that an epidemic is already occurring, SDI-EPI can be used to infer the identities and locations of potentially exposed individuals, and to assist in the optimization of hospital logistics. It is worthy to note that because of the diverse variety and number of attributes which may be leveraged by the present system in combination with the fact that the actual statistical patterns and relationships between these attributes is very difficult to predict, while the variables which must be employed for determining and quantifying these attributes is often of a highly probabilistic and indeterminate nature, the algorithmic formalisms which have herein been disclosed are highly representative of a “best of breed” methodologies which are particularly important given the unique characteristics of the inputs and desired outputs of the presently proposed system. With that said, the particular algorithmic techniques which are cited (as they are presumed most suitable for a given problem/solutions set) are in no way intended to limit the range of scope of the potential methods which may be typified by the one or ones suggested or potentially others which may be more dissimilar though sub-optimal in terms of efficiency or accuracy.

Those skilled in the art will also appreciate that the invention may be applied to other applications and may be modified without departing from the scope of the invention. Accordingly, the scope of the invention is not intended to be limited to the exemplary embodiments described above, but only by the appended claims.

What is claimed:

1. An adaptive machine learning system configured to receive inputs including medical, commercial, criminal, and private records and communications relating to a plurality of individuals in one or more geographic areas, to process the inputs using a predictive model to identify abnormalities in the inputs indicative of an epidemic outbreak in a geographic area, and to suggest a recommended reactive protocol to the epidemic.

2. A system as in claim 1, wherein the adaptive machine learning system comprises a Bayesian Belief Network including said predictive model, said Bayesian Belief Network processing said inputs to identify said abnormalities.
